(19) United States
(12) Patent Application Publication
(10) Pub. No.: US 2009/0327871 A1
(43) Pub. Date: Dec. 31, 2009

(54) I/O FOR CONSTRAINED DEVICES

(75) Inventors: Richard J. Wolf, Seattle, WA (US); Jensen M. Harris, Kirkland, WA (US); Srikanth Shoroff, Sammamish, WA (US); Eran Megiddo, Bellevue, WA (US); Rajesh Jha, Bellevue, WA (US); Joshua T. Goodman, Redmond, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/146,911

(22) Filed: Jun. 26, 2008

(51) Int. Cl. G06F 3/14

(52) U.S. Cl. 715/243; 715/273

(57) ABSTRACT

Systems and methodologies for providing improved input and output capabilities for computing devices are provided herein. An output manager is provided that can determine an appropriate layout for a user interface at a display area based on size and shape parameters associated with the display area. The output manager can additionally sense alterations to the display area and dynamically adjust a determined layout based on the sensed alterations. Further, the output manager can facilitate the connection of an associated device to one or more external display devices to facilitate the combined use of the external display devices and resident display areas at the associated device. An input manager is additionally provided that can obtain input from a target user by sensing patterns associated with the target user and select an appropriate input based on the sensed patterns.

### BACKGROUND

Computing devices, such as personal computers (PC), laptop computers, and mobile computing devices such as cellular telephones, personal digital assistants (PDAs), and the like, have significantly increased in use and prevalence in recent years. Today, an ever-expanding portion of the population utilizes computing devices for multimedia, word processing, and other computing applications. However, despite the processing power currently possessed by even the smallest form-factor mobile computing devices, conventional computing devices are limited in the shapes and types of display areas that can be utilizes, which prevent them from being used to their full potential. For example, conventional viewing areas for computing devices are generally very rigidly limited to a rectangular area of a predetermined size. As a result of these rigid display limitations, computing applications that could potentially benefit from a display area of an alternate type and/or shape are unable to enjoy the benefits of such an alternate display area without extensive and complex customization for each type and/or shape of display area on which the application could be used. Further, these conventional display limitations do not allow a display area to adapt to changing context, environmental conditions, or similar factors, which can limit the effectiveness of a traditional computing device display under various circumstances. Accordingly, there exists a need for improved display techniques for mobile devices and other computing devices.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems and methodologies in accordance with embodiments described herein provide improved input and output capabilities for small form-factor mobile devices and other suitable devices. In accordance with one aspect, an output manager for a device such as a small form-factor device is provided that facilitates flexible display of user interface information over multiple types of display areas. In one example, the output manager can determine an appropriate layout for a user interface at a display area based on the size of the display area, the shape of the display area, user preferences, and/or other factors and display the user interface using the determined layout. The output manager can determine a layout for a user interface in an application-independent manner, thereby allowing an application to effectively utilize display areas of various sizes and shapes without requiring customization of the application for each size and shape.

In another example, the output manager can sense alterations to a display area and dynamically adjust a determined layout based on the sensed alterations. For example, if a retractable projector screen is utilized as a display area, the output manager can detect retractions and/or protractions to the projector screen and dynamically adjust the determined layout based on the changing effective area of the screen. The output manager can additionally facilitate the connection of an associated device to one or more external display devices, such as a computer monitor and/or other appropriate device, to facilitate the combined use of the external display devices and resident display areas at the associated device. Further, the output manager can facilitate the creation and use of a distributed user interface across multiple mobile and/or other devices, in which input and/or output can be shared across devices for unified operation thereof In another example, the output manager can also leverage features particular to mobile devices, such as activating vibration and/or a ringtone, in addition to displaying information.

In accordance with another aspect, an input manager is provided that obtains input from a target user by sensing patterns associated with the target user outside of the physical dimensions of an associated device. In one example, the input manager can project a virtual keyboard onto a surface. When a target user types against the virtual keyboard, the mobile device can infer desired inputs by sensing hand movements of the target user relative to the virtual keyboard. Therefore, a user can type against conceivably a full-sized and full-featured keyboard that is comfortable and adaptable, yet also small and easily portable since it is virtualized. In another example, multi-modal input patterns can be received and utilized by the input manager for determining desired inputs from a target user. For example, the input manager can employ voice recognition techniques for interpreting vocal commands in conjunction with input patterns obtained using a different input modality. As another example, the input manager can be utilized in combination with an infrastructure of external input and/or output devices, such as external keyboards and display screens, to give target users widespread access to convenient input and output devices.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIGS. 1-2 illustrate example user interfaces in accordance with various aspects.

FIG. 3 is a block diagram of a system for dynamically adjusting projection of information in accordance with various aspects.

FIG. 4 is a block diagram of a system that facilitates interaction with a mobile device.

FIG. 5 is a block diagram of a system for displaying a user interface at a mobile device.

FIG. 6 is a block diagram of a system for displaying a user interface for a set of applications based on parameters relating to a display area.

FIG. 7 is a block diagram of a system for dynamically adjusting a user interface based on sensed alterations to a display area.

FIG. 8 is a block diagram of a system that provides distributed interface capabilities across multiple devices.

FIG. 9 is a block diagram of a system for providing input to a small form-factor device.

FIG. 10 is a block diagram of a system for providing multi-modal input to a mobile device.

FIG. 11 is a block diagram of a system for providing input to a device via a virtual interface.

FIG. 12 is a block diagram of a system for providing input to a mobile device via a remote input device

FIG. 13 is a flowchart of a method of generating and utilizing a layout for the display of a user interface at a display area.

FIG. 14 is a flowchart of a method of dynamically generating and adjusting a layout for a display area.

FIG. 15 is a flowchart of a method of receiving and processing user input patterns from an external input interface.

FIG. 16 illustrates a block diagram of a computer operable to execute the disclosed architecture.

FIG. 17 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” “interface,” “schema,” “algorithm,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Additionally, while the following description generally relates to input and output devices that can be used for small form-factor mobile devices, those skilled in the art will recognize that the embodiments described herein can be applied to any computing device or other suitable device that provides input and/or output capabilities. It is to be appreciated that the systems and/or methods described herein can be employed with any suitable type of device and that all such types of device(s) are intended to fall within the scope of the hereto appended claims.

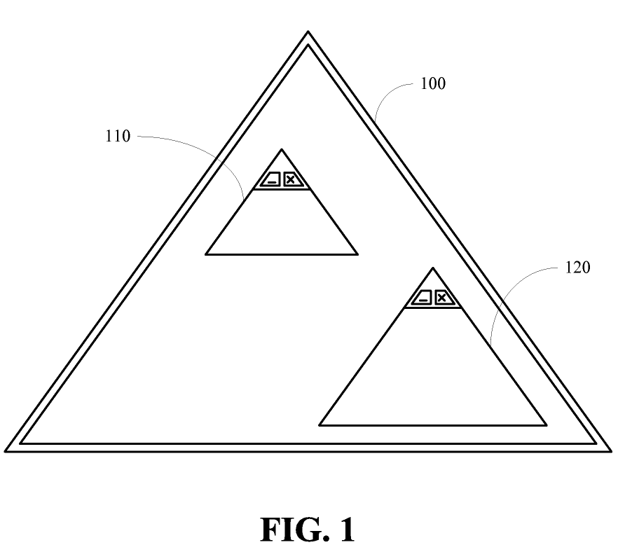

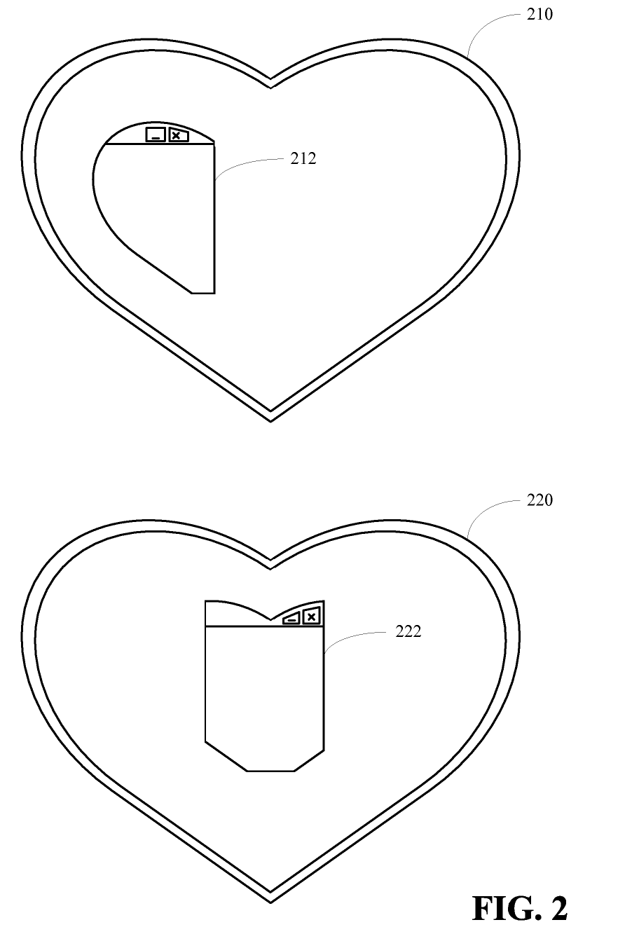

Referring now to the drawings, FIGS. 1-2 illustrate example user interfaces that can be implemented in accordance with various aspects described herein. It should be appreciated, however, that the user interfaces illustrated by FIGS. 1-2 are provided by way of example and not limitation and that other user interfaces could also be implemented as described herein. Further, it is to be appreciated that FIGS. 1-2 are not drawn to scale from one figure to another nor inside a given figure, and in particular that the size of the components are arbitrarily drawn for facilitating the reading of the drawings.

Referring to FIG. 1, an example user interface that can be implemented in accordance with various aspects described herein is illustrated. In one example, the user interface can be implemented on a display screen 100 and can include one or more windows 110 and/or 120. Display screen 100 is illustrated in FIG. 1 as triangular in shape, but it should be appreciated that display screen 100 could be any appropriate shape. Moreover, it should be appreciated that display screen 100 can be associated with a computing device (e.g., a personal computer, a laptop computer, a tablet computer, etc.), a mobile device such as a personal digital assistant (PDA) or a mobile telephone, a television or other similar device, and/or any other suitable device.

In accordance with one aspect, the display of a user interface at a display area such as display screen 100 can be configured automatically and in an application-independent manner. By doing so, windows 110 and/or 120 and/or other information on display screen 100 can be adaptably displayed without requiring applications to be customized for each type of display screen on which the applications could be executed. In one example, a user interface can be generated for a display screen 100 by first collecting information relating to the size and shape of the display screen 100, from which the size and shape of the display screen 100 can be determined. Based on this information, a generalized coordinate system or other means can be utilized to configure sizes and shapes of windows 110 and/or 120 or other graphics that are identified for display on the display screen 100. For example, as illustrated by FIG. 1, windows 110 and 120 at display screen 100 can be configured to be triangular in shape to match the shape of the display screen 100 based on information collected relating to the display screen 100. Further, as illustrated by FIG. 1, control regions and/or other portions of respective windows 110 and/or 120 at the display screen 100 can be adapted to the shapes of the respective windows.

Turning to FIG. 2, another example user interface that can be implemented in accordance with various aspects described herein is illustrated. In one example, a user interface displayed at a display screen can begin in a first state as illustrated by display screen 210. It should be appreciated, however, that while FIG. 2 illustrates a heart-shaped display, other shapes can also be utilized. Further, a window 212 can be displayed at display screen 210. As illustrated by display screen 210, window 212 begins entirely within the left half of display screen 210. Accordingly, window 212 can be configured in size and shape for display at the left half of the display screen 210 in a similar manner described to that for FIG. 1.

In the event that window 212 is moved away from the left half of the display screen 210, a user interface can enter a second state as illustrated by display screen 220. As the window 222 is moved within the display screen 220, the shape of the window 222 can be dynamically adjusted based on its position within the display screen 220. As a specific example, if window 222 is moved horizontally across the center of display screen 220, it can be dynamically configured to conform to the shape of the display screen based on its location as illustrated by FIG. 2.

In accordance with one aspect, an interface can be generated for a desired size and/or shape in various manners. For example, as illustrated by FIGS. 1-2, an interface can be generated having a size and shape that conform to a display screen on which the interface is to be displayed. Information regarding the shape of an associated display screen can be obtained directly from the display screen, from cameras and/or other sensors associated with the display screen, and/or in any other suitable manner. Further, an interface can be generated having a size and shape that are determined based at least in part on a set of user preferences and/or contextual information. Contextual information that can be utilized in determining a size and/or shape for an interface can include, for example, information regarding location of the computing device and/or content of the interface. By way of specific example, a size and shape for an interface generated for a presentation can be selected based on the text of the presentation, the location of the presentation (e.g., the geographic location at which the presentation is given, the type of building in which the presentation is given, etc.), the identity of the presenter(s), and the like. In another example, a user profile can be maintained on a computing device, into which user preferences and/or contextual information can be stored and utilized to determine a size and shape for a display at the computing device.

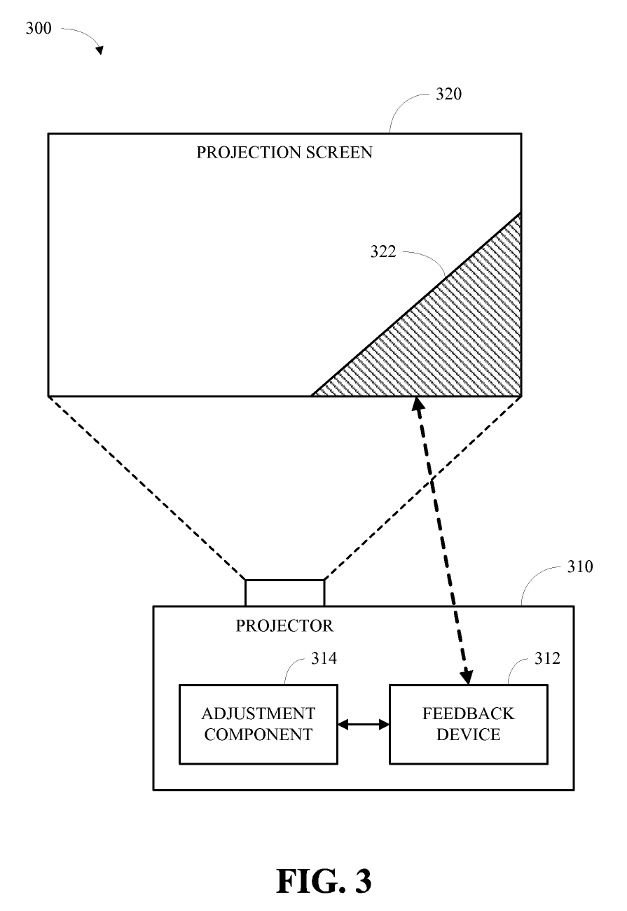

Referring now to FIG. 3, a system 300 for dynamically adjusting projection of information is illustrated. System 300 can include a projector 310, which can project information such as a user interface onto a projection screen 320 and/or another appropriate area. In one example, projector 310 can include a feedback device 312 that can dynamically monitor the viewable area of the projection screen 320 and/or another area onto which the projector 310 is displaying information. The feedback device 312 can employ a camera, an optical sensor, an infrared sensor, and/or any other appropriate type of sensing mechanism in making its determination. Based on information from the feedback device 312, an adjustment component 314 at the projector 310 can then dynamically adjust the projection of information to accommodate the viewable portion of the projection screen 320 and/or other area onto which the projector 310 is displaying information.

Determinations made by the feedback device 312 can include, for example, determining whether an obstruction 322, such as an object placed in front of the projector screen 320 or a person walking in front of the projector screen 320, is present. Additionally and/or alternatively, in an example where the projector screen 320 can be rolled away or is otherwise collapsible, determinations made by the feedback device 312 can include determining a portion of the projection screen 320 that has been rolled out or expanded for use. Based on these determinations, the adjustment component 314 can then dynamically adjust the size and shape of an area onto which the projector displays information. In addition to making adjustments to the size of the overall display area, the adjustment component 314 can also adjust windows and/or other graphics within the display area based on the adjusted size and/or shape of the display area in a similar manner to that illustrated by FIGS. 1-2. In another example, the feedback device 312 can determine whether and to what extent image skewing (e.g., “keystoning”) is present at the projection screen 320 to facilitate automatic correction of the image skewing by the adjustment component 314.

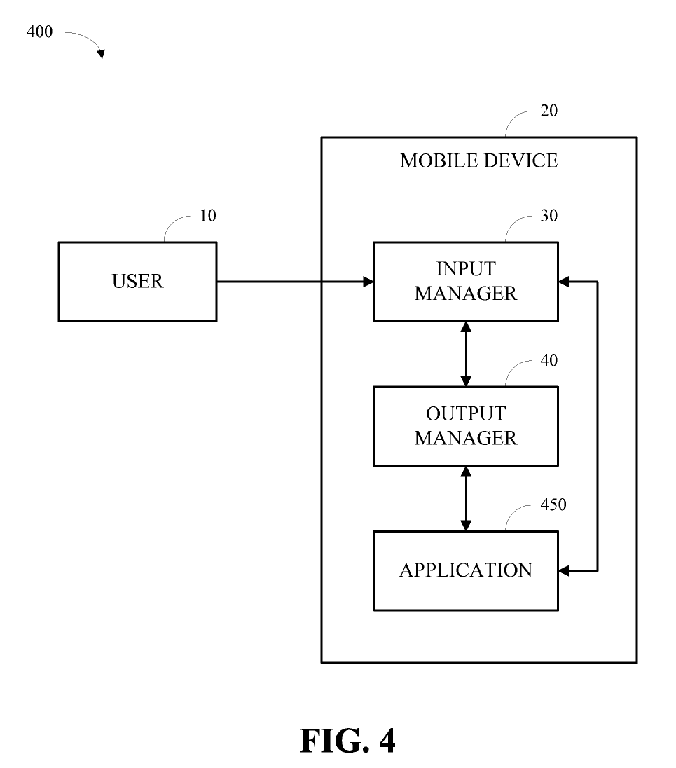

Referring now to FIG. 4, a block diagram of a system 400 that facilitates interaction between a user 10 and a mobile device 20 is illustrated. Traditionally, a user 10 can interact with a small form-factor mobile device 20 such as a cell phone, PDA, or other such device to execute one or more applications 450 at the mobile device 20. However, the size of a mobile device 20 often limits the input and output capabilities thereof, rendering the performance of any application on a mobile device 20 that is more than cursory in nature difficult or impossible. To mitigate these shortcomings, one aspect of the claimed subject matter provides an input manager 30 and an output manager 40 that can respectively provide richer, more intuitive input and output for an associated mobile device 20, thereby allowing a user 10 to perform applications on the mobile device 20 that more effectively utilize the features and processing power of the mobile device 20. In one example, the input manager 30 and output manager 40 can be associated with a particular application 450 located at the mobile device 20. Alternatively, the input manager 30 and output manager 40 can be integrated into an operating system for the mobile device 20 or otherwise be implemented as application-independent features of the mobile device 20.

In accordance with one aspect, the input manager 30 can allow a user 10 to provide input to an associated mobile device 20 outside of the physical dimensions of the mobile device 20 using methods conventionally associated with full-sized and full-featured input devices without requiring such devices. As a result, portability and other benefits associated with the small form factor of a mobile device 20 can be maintained without the conventional sacrifice in input functionality. In one specific, non-limiting example, the input manager 30 can provide a virtualized keyboard onto which a user 10 can engage in typing motions. Based on patterns associated with the typing motions of the user 10, the input manager 30 can determine keystrokes associated with the patterns.

In another example, the input manager 30 can utilize multi-modal input patterns from a user 10 to determine a desired input. For example, an audio receiver with speech recognition capabilities can be utilized by the input manager 30 to interpret spoken commands that can be provided by a user 10 in addition to other inputs provided to the mobile device 20. Additionally and/or alternatively, the input manger can employ a low-cost biometric device to monitor the brainwaves of a user 10, which can be used in connection with other sensed input patterns to provide input for the mobile device 20. As another example, the input manager 30 can be operable to interface with external input peripherals such as keyboards, mice, and/or other devices, which can be provided in a network or internetwork infrastructure to be quickly and easily accessible to users 10. An external input peripheral(s) can be communicatively associated with the mobile device 20 via the input manager 30, thereby enabling a user 10 to provide input to the mobile device 20 using the connected peripheral device(s) in place of or in addition to local input devices at the mobile device 20.

In accordance with another aspect, a mobile device 20 can include an output manager 40 that flexibly generates and provides a layout for the display of information at one or more display areas associated with the mobile device 20, thereby allowing the mobile device 20 to overcome many of the shortcomings of small, rectangular mobile display screens conventionally utilized by small form-factor devices. In one example, the output manager 40 can permit a display screen associated with the mobile device 20 to be non-rectangular. In such an example, the output manager 40 can determine the size and shape of the non-rectangular display screen and/or other parameters relating to the display screen and can generate a layout for the display of information received from an application 450 and/or another suitable source based on the generated layout. Traditionally, applications have required customization for every size and shape of display screen for which the applications are to be utilized. This limitation has traditionally limited the supported display areas for many applications to a small number of standard sizes and shapes, which has made the incorporation of non-standard display area sizes and shapes prohibitively difficult. In contrast, the output manager 40 can generate a layout for information in an application-independent manner, thereby removing the traditional limitations associated with the requirement of customized applications for non-standard displays. In another example, a layout generated by the output manager 40 can affect respective sizes of windows in an associated display area as well as respective shapes of the windows. For example, the output manager 40 can determine that a non-rectangular window shape is preferred for all or part of a display area based on the shape of the display area and generate a layout for the display area accordingly.

In another example, the output manager 40 can also be used to interface an associated mobile device 20 to one or more external display screens. The output manager 40 can interface with external display screens by, for example, communicating with the external display screens through a network or internetwork infrastructure on which the external display screens are deployed and/or by other means of wired and/or wireless communication. Upon interfacing with one or more external display areas, the output manager can then generate and provide a layout for displaying information at the external display area(s). In addition, the output manager 40 can simultaneously utilize a combination of display areas associated with the mobile device 20 and/or external display areas as a common display area, even in cases where the resulting display area is non-rectangular, by making appropriate adjustments to a generated layout for displayed information. The output manager 40 can further sense alterations to a display area(s) associated with the mobile device 20 and dynamically adjust a layout used for displaying information at the display area(s). For example, the output manager 40 can adjust a layout for information to reflect an external display area that has been newly connected or disconnected; a change in the effective size and/or shape of a connected display area, such as a change effected by expanding or collapsing a collapsible display area; and/or other alterations.

As another example, the output manager 40 can receive information for display from a source external to the mobile device 20. The output manager 40 can dynamically generate a layout for this information and display the information at a local display at the mobile device 20 and/or at one or more external display screens. In addition, the output manager can utilize one or more features unique to the mobile device 20 such as a ringtone and/or vibration in connection with the delivery of the information. In one example, the output manager 40 can utilize these features on its own accord based on predetermined criteria without specific direction from the source of the information.

In accordance with an additional aspect, the input manager 30 and the output manager 40 can operate cooperatively to provide a distributed user interface across multiple mobile devices 20 and/or other devices. For example, the input manager 30 and output manager 40 can facilitate the use of the mobile device 20 with one or more external devices to simultaneously control a common interface. More particularly, the input manager 30 can coordinate input across the devices while the output manager can coordinate the display of the common interface across respective device displays. As a specific, non-limiting example, a distributed user interface can be utilized in this manner to allow a mobile device 20 to be used with a computing device for distributed computing tasks. As another specific example, a common interface can be utilized in the above manner to allow a document to be edited by multiple devices, potentially being operated by multiple users 10, simultaneously.

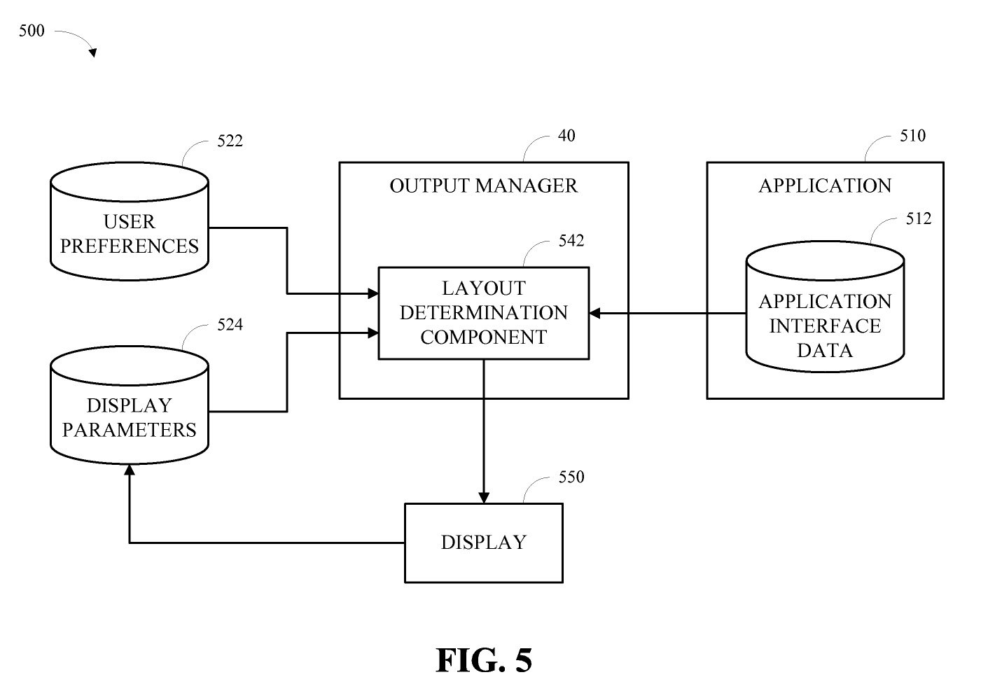

Referring to FIG. 5, a system 500 for displaying a user interface at a mobile device is illustrated. In one example, the system 500 includes an output manager 40 that can provide enhanced output capability for a device (e.g. a mobile device 20) in accordance with various aspects. The output manager 40 can interact with an application 510 to receive application interface data 512. The application 510 can be, for example, a local application at the mobile device employing the output manager 40 or an application residing at an external device. In accordance with one aspect, the application interface data 512 can be provided to the output manager 40 for display at a display area 550. By way of example, the display area 550 can be a local display at the mobile device, an external display communicatively connected to the mobile device, or a combination thereof.

In one example, provided application interface data 512 may not be formatted by an application 510 providing the data for the particular size and/or shape of a display area 550. Accordingly, the output manager 40 can utilize a layout determination component 542 to dynamically create a layout for the application interface data 512. The layout determination component 542 can create a layout for the application interface data 512 based on, for example, the application interface data 512, a set of display parameters 524 relating to the display area 550, user-provided preferences 522, and/or other appropriate factors. The output manager 40 can then display the application interface data 512 according to the created layout at the display area 550.

In accordance with another aspect, the output manager 40 can leverage one or more features commonly provided by mobile devices, such as a ringtone or vibration, in connection with the display of the application interface data 512. By way of specific, non-limiting example, the application 510 can be a distributed document editing program or a similar shared data store, and the output manager 40 can trigger a ringtone at the mobile device associated with the output manager 40 upon an update to a document and/or other data associated with the application 510. More generally, an output manager 40 can also utilize a ringtone or vibration feature of an associated mobile device in connection with any event in an application 510 having a predetermined priority level. In one example, the output manager 40 can be configured to utilize a ringtone or vibration feature of an associated mobile device independently and without specific instruction from the application 510 to do so. For example, the output manager 40 can leverage a ringtone of a mobile device upon receiving an update from an application 510 that is not primarily designed for mobile devices and therefore lacks the capability to request the activation of such a feature on its own.

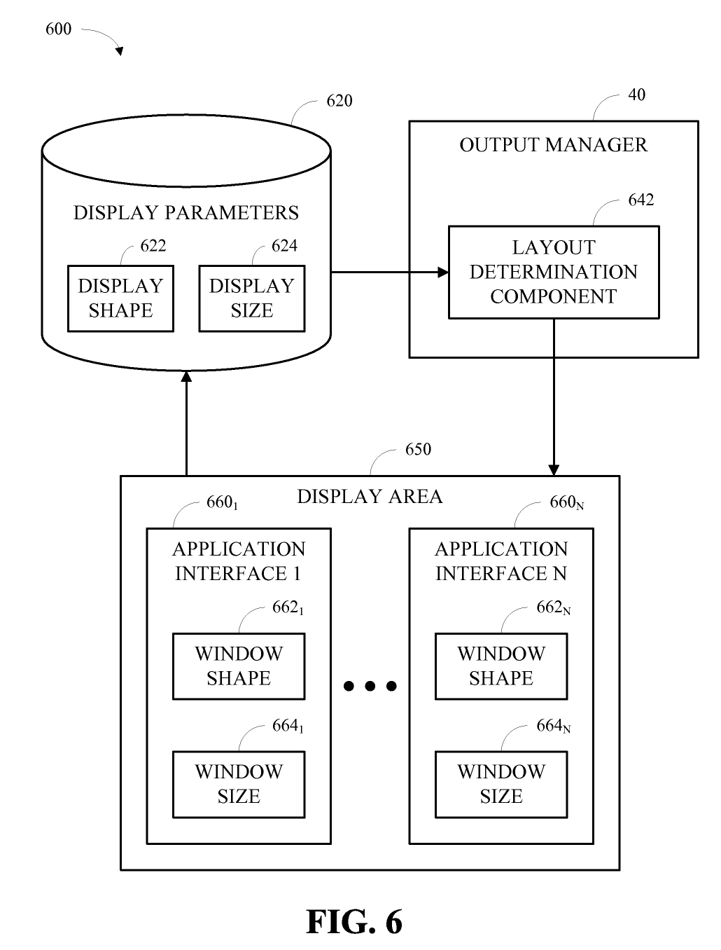

Turning to FIG. 6, a system 600 for displaying a user interface for a set of applications based on parameters relating to a display area is illustrated. System 600 can include an output manager 40, which can be associated with a mobile device (e.g., a mobile device 20) or another suitable device. In accordance with one aspect, the output manager 40 includes a layout determination component 642 that can receive a set of display parameters 620 relating to a display area 650 to generate a layout for use at the display area 650. The display area 650 can include one or more local display screens at a device associated with the output manager 40 and/or one or more external display screens.

In accordance with another aspect, display parameters 620 relating to the display area 650 can include display shape parameters 622 relating to the shape of display area 650 and/or display size parameters 624 relating to the size of display area 650. The layout determination component 642 can then employ these parameters to generate a layout for the display area 650. This generated layout can be utilized to display information relating to, for example, one or more applications and/or other suitable sources. In one example, the layout determination component 642 can determine a layout for the display area 650 in an application-independent manner, thereby allowing an application to effectively utilize display areas of various sizes and shapes without requiring customization of the application for each such size and shape. By way of example, the layout determination component 642 can be utilized to support non-rectangular display areas 650, which have conventionally been difficult to utilize due to the difficulties traditionally associated with customizing applications for such display areas.

In another example, a layout generated by the layout determination component 642 can correspond to one or more application interfaces 660 to be displayed at the display area 650. Separate application interfaces 660 can be provided for each individual application for which information will be displayed on display area 650, or alternatively a common application interface 660 can be shared among multiple applications. Further, an application can be given more than one application interface 660. Application interfaces 660 generated by the layout determination component 642 can correspond to a single generated layout or a combination of layouts corresponding to each application interface 660. In one example, each application interface 660 to be utilized at display area 650 can have associated window shapes 662 and/or window sizes 664 based on the display parameters 620. The window shapes 662 and window sizes 664 for each application interface 660 can be determined, for example, based on the shape and size of the display area 650. Further, window shapes 662 and window sizes 664 for a given application interface 660 can vary based on positioning of a corresponding window in the display area 650. As a specific example, a layout can be generated by the layout determination component 642 for a circular or semicircular display area 650. A window shape 662 can be defined for the display area 650 such that a window is displayed as a rectangle if it is not placed alongside a circular edge of the display area 650. If the window is then moved to a circular edge of the display area 650, a window edge placed along a circular edge of the display area 650 can be made circular to conform to the edge of the display area 650.

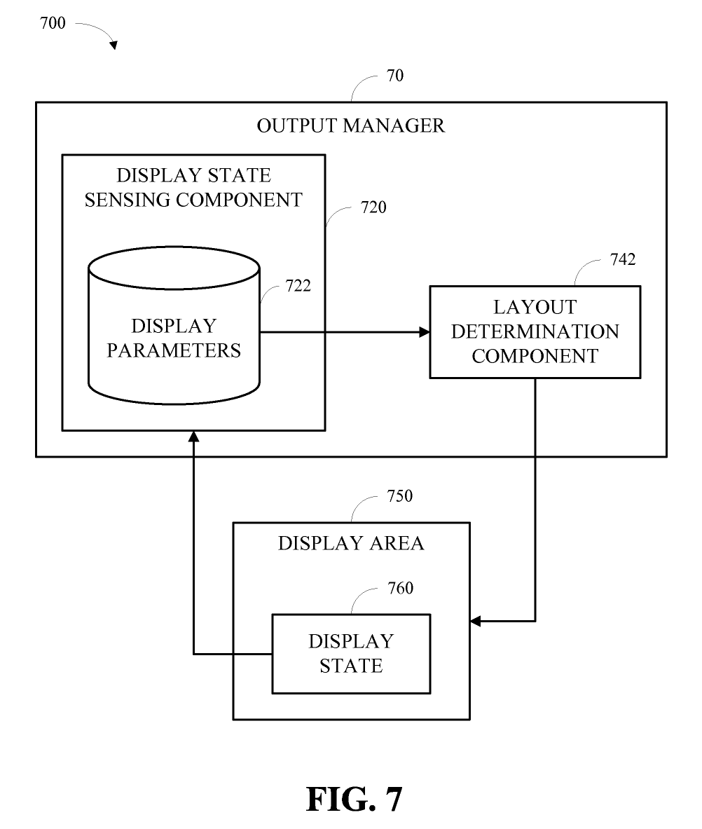

Referring to FIG. 7, a system 700 for dynamically adjusting a user interface based on sensed alterations to a display area is illustrated. In accordance with one aspect, system 700 includes an output manager 40 associated with a mobile device or another suitable device. Output manager 40 can include a layout determination component 742, which can generate a layout for displaying information at display area 750 based on parameters 722 relating to the display area 750 in a similar manner to layout determination components 542 and 642.

In accordance with another aspect, output manager 40 can further include a display state sensing component 720, which can monitor a display state 760 associated with a current effective size and/or shape of the display area 750 and dynamically adjust corresponding display parameters 722 for use by the layout determination component 722 based on the monitored state. In one example, the display state sensing component 720 can continuously monitor a display state 760 corresponding to a display area 750, thereby enabling the output manager 40 to determine which parts of the display area 750, if any, are viewable at a given time. Based on this information, the layout determination component 742 can dynamically modify a layout for use by the display area 750.

By way of non-limiting example, the display area 750 can include a rolling projection screen. Accordingly, the display state 760 monitored by the display state sensing component 720 can correspond to a portion of the projection screen that has been rolled out for use. In such an example, the display state sensing component 720 can employ motion sensing, optical tracking, and/or other appropriate monitoring techniques to continuously sense the position of the projection screen and adjust the display parameters 722 based on the sensed position. The layout determination component 742 can then utilize the display parameters 722 provided by the display state sensing component 720 to dynamically adjust a layout used for display on the projection screen. Thus, the display state sensing component 720 and the layout determination component 742 can cooperatively adjust the display of information at the display area 750 in real time to account for changes in the viewable area of the display area 750.

As another non-limiting example, the display state sensing component 720 can utilize motion tracking, optical sensing, and/or other appropriate techniques to monitor the display area 750 for obstructions that prevent a portion of the display area 750 from being visible. When the display state sensing component 720 discovers an obstruction, the display state sensing component 720 can then determine which areas of the display area 750, if any, are visible despite the obstruction and generate display parameters 722 corresponding to the visible portions of the display area 750. The layout determination component 742 can then utilize the display parameters 742 to configure the display of information at only visible portions of the display area 750. In a further example, window shapes and/or sizes can be adapted for irregularities in the overall shape of the viewable portion of the display area 750 in a similar manner to that described with regard to layout determination component 642.

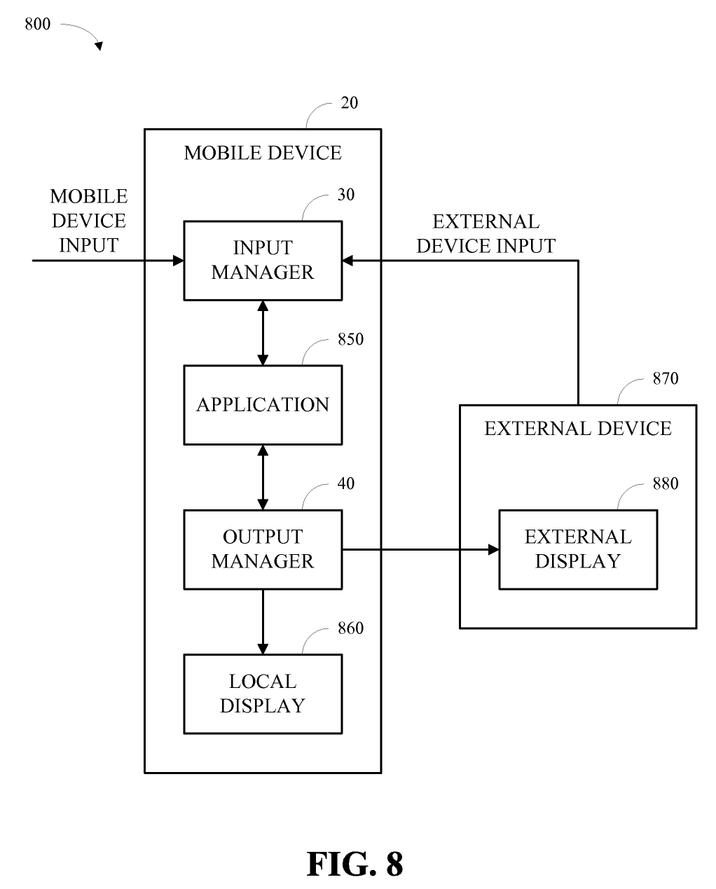

Turning now to FIG. 8, a system 800 that provides distributed interface capabilities across multiple devices is illustrated. In one example, the system includes a mobile device 20 on which one or more applications 850 can be executed (e.g., by a user 10). The mobile device 20 can include an input manager 30 that can obtain and interpret input provided directly to the mobile device 20 in accordance with various aspects. The mobile device 20 can further include an output manager 40, which can facilitate the display of information relating to one or more applications 850 on a local display 860 at the mobile device 20 and/or one or more external displays 880. As a specific example, the output manager 40 can communicate with external displays 880 and/or other output devices that are deployed as part of an infrastructure of available output devices.

In another example, the output manager 40 can coordinate between a local display 860 and/or one or more external displays 880, each of which can differ in display size, color depth, resolution, and/or other parameters, to utilize the coordinated displays as a single combined display area on which to display information corresponding to one or more applications 850. In accordance with one aspect, in the event that one or more of the display areas 860 or 880 or the resulting combined display area is non-rectangular, the output manager 40 can utilize a specialized coordinate system and/or one or more specialized layout mechanisms to effectively utilize the non-rectangular display area(s). In one example, the output manager 40 can establish a common display area between a smaller local display 860 and a larger external display 880 and utilize one or more layout mechanisms to determine whether a given piece of information is more appropriate for display at the local display 860 or the external display 880. In another example, the output manager 40 can form a common display area of a predetermined size and shape from a set of local and/or external micro-screens and/or other suitable modular display areas that are communicatively connected to the output manager 40.

In accordance with another aspect, an input manager 30 and an output manager 40 at a mobile device 20 can cooperate to provide a distributed user interface with one or more external devices 870. For example, an external device 870 can correspond to a device deployed in a network or internetwork infrastructure having both a remote input device and an external display 680. By connecting the external device 870 to a mobile device 20, an input manager 30 at the mobile device 20 can utilize both local inputs entered directly to the mobile device 20 as well as external inputs supplied by the external device 870. Further, an output manager 40 at the mobile device 20 can utilize a local display 860 at the mobile device 20 and the external display 880 as a common display area for display output. During a communication session with the external device 870, the input manager 30 and output manager 40 can also track and record applications 850 used by the mobile device 20, states of such applications, input and/or output capabilities of the external device 870, and/or other useful information. This information can be stored by the mobile device when the communication session between the mobile device 20 and the external device 870 is terminated, such that the applications 680 can be quickly returned to their previous state upon beginning a new communication session with an external device 870. In one example, the input manager 30 and output manager 40 can make adjustments for input and/or output capabilities of a newly connected external device 870 in the event that such capabilities differ from those of a previously connected device.

In a specific, non-limiting example, input managers 30 and output managers 40 at respective mobile devices 20 can communicate with each other, thereby allowing users of the respective mobile devices 20 to simultaneously utilize a common user interface. In one example, a document editing application can be commonly executed by the mobile devices 20. More particularly, input managers 30 and output managers 40 at communicating mobile devices 20 can be used to allow users of the respective devices to simultaneously edit a common document, the results of which can be displayed as common output among local displays 860 at the mobile devices 20 and/or connected external displays 880.

In another specific, non-limiting example, an input manager 30 and an output manager 40 can be used by a mobile device 20 to facilitate communication between the mobile device 20 and a larger computing device, such as a personal computer or a laptop computer. Once connected, the mobile device 20 and the computing device can be utilized together by a user to perform various distributed computing and/or other tasks. In one example, the input manager 30 at the mobile device 20 can facilitate sharing of inputs between the mobile device 20 and the computing device, while the output manager 40 can similarly create a common display area using a local display 860 at the mobile device and one or more display areas at the computing device. As a further specific example, the mobile device 20 and computing device can cooperate to perform specialized actions upon the performance of predetermined actions by a user. For example, a user can provide input to either the mobile device 20 or the computing device to drag a file from a local display 860 at the mobile device 20 to a display of the computing device to trigger a predetermined action, such as the publication of the dragged file to a specified location on the Internet.

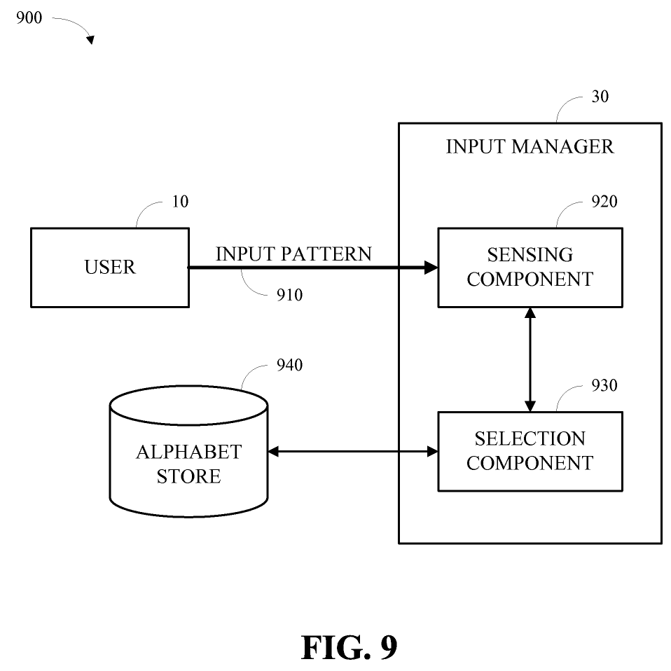

Referring now to FIG. 9, a system 900 for providing input to a small form-factor device (e.g., a mobile device 20) is illustrated. In one example, a user 10 can interact with an input manager 30 provided by system 900 to provide input to a small form-factor device associated with the input manager 30. A user 10 can provide input to the input manager 30 in the form of input patterns 910, which can be sensed by a sensing component 920 at the input manager 30. In accordance with one aspect, the input patterns 910 sensed by the sensing component 920 can be provided externally to the device associated with the input manager 30, thereby facilitating the entry of input to a small, portable device using similar methods to those associated with larger, less portable devices.

By way of specific, non-limiting example, the sensing component 920 can monitor input patterns 910 from a user 10 in one or more of the following ways. It should be appreciated that the following is provided by way of example and not limitation and that additional monitoring techniques can be employed by the sensing component 920. Further, it should be appreciated that all suitable monitoring techniques employable by the sensing component 920 are intended to fall within the scope of the hereto appended claims. In one example, the sensing component 920 can monitor input patterns 910 corresponding to hand and/or body movements of a user 10 by employing one or more motion and/or position tracking techniques. For example, the input manager 30 can virtualize a conventional input device, such as a keyboard or mouse, and convey the virtualized input device to a user 10. The user 10 can then move his hands and/or body with respect to the virtualized input device as if he was using an actual, non-virtualized input device. By using a video tracking system and/or other appropriate motion sensor, the sensing component 920 can then detect the movements of the user 10 with respect to the virtualized input device. The sensed movements can then be used to facilitate the communication of corresponding inputs to a device associated with the input manager 30.

In another example, the input patterns 910 received from a user 10 can include spoken commands and/or other aural patterns. The sensing component 920 can monitor these aural patterns by, for example, employing an audio receiver with speech recognition and/or other audio recognition capabilities.

In an additional example, the sensing component 920 can determine or verify intended user input by employing a biometric monitor, such as a low-cost biometric device, to monitor input patterns 910 in the form of brain activity of a user 10. For example, a biometric monitor can be employed by the sensing component 920 in connection with a virtualized input device as described supra to determine and/or correct input patterns 910 corresponding to interaction between a user 10 and the virtualized input device. Biometric input patterns 910 monitored by the sensing component 920 can include brain activity of the user 10 relative to his interaction with the virtualized input device, such as the intended speed and trajectory of the user's hand movements or, in the specific example of a virtualized keyboard, stimuli corresponding to particular keystrokes intended by the user 10. By way of another specific, non-limiting example, the sensing component 920 can utilize a biometric monitor more generally to sense brain activity of a user 10 corresponding to particular inputs, such as letters or words, which the user 10 desires to provide to a mobile device associated with the input manager 30. This sensed brain activity can then be used alone or in combination with other inputs and/or input patterns 910 to provide the desired inputs to the associated device.

In yet another example, the sensing component 920 can be utilized to monitor input patterns 910 corresponding to engaged areas of an external touch-sensitive or pressure-sensitive surface. By way of example, the surface can be a collapsible and/or folding sheet or a similar surface provided by a mobile device that can be directly monitored by the sensing component 920. Alternatively, the surface can be external to the mobile device and relay information regarding engaged areas to the sensing component 920, which can then determine input patterns 910 indirectly from the received information.

In accordance with another aspect of the claimed subject matter, the input manager 30 can also include a selection component 930 that utilizes input patterns 910 sensed by the sensing component 920 to determine a desired input from a user 10. In one example, the selection component 930 can determine a desired input by selecting from a set of potential inputs provided by an alphabet store 940. The alphabet store 940 can correspond to a universal alphabet, such as a set of possible keyboard keystrokes, and/or an application-specific alphabet, such as a set of application-specific commands. Further, multiple alphabet stores 940 can be utilized by the selection component 930. In one example, an alphabet store(s) 940 utilized by the selection component 930 can be provided by an application being executed by a user 10 at an associated mobile device, a dedicated alphabet generation application, an operating system for the associated mobile device, and/or any appropriate entity internal or external to the associated mobile device. Additionally, respective alphabet stores 940 utilized by the selection component 930 can be dynamically modified by respective entities providing the alphabet stores 940.

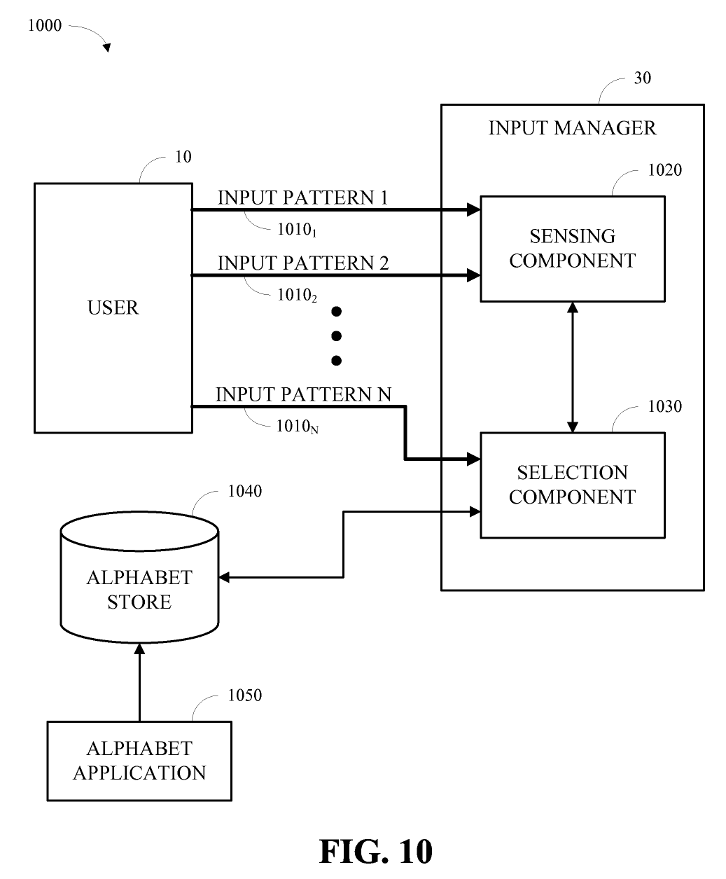

Turning to FIG. 10, a system 1000 for providing multi-modal input to a mobile device is illustrated. In one example, the system 1000 includes an input manager 30 associated with a mobile device, to which a user 10 can provide input patterns 1010 using a combination of input modalities. The input manager 30 can include a sensing component 1020 that can operate similarly to the sensing component 220 in system 200 to monitor one or more of the input patters 1010. A selection component 1030 at the input manager 30 can then be used to select inputs from an alphabet store 1040 based on the monitored input patterns 1010. As a specific, non-limiting example, the sensing component 1020 can employ a motion tracking mechanism to monitor the movements of a user 10 as well as an audio receiver to monitor spoken commands from the user 10 and/or a biometric sensor to monitor brain patterns of the user 10.

In another example, the sensing component 1020 can be used to monitor only a subset of the input patterns 1010 provided by the user 10. Instead, one or more of the input patterns 1010 can be directly provided to the selection component 1030 to facilitate selection of inputs from one or more alphabet stores 1040 using the directly-received input pattern(s) 1010 in addition to monitored input pattern(s) 1010 from the sensing component 1020. An input pattern 1010 provided directly to the selection component 1030 can correspond to, for example, interaction between a user 10 and a conventional input device such as a keypad or touch screen.

In accordance with one aspect, an alphabet store 1040 can correspond to a set of possible inputs based on one or more input patterns 1010 received by the selection component 1030. Further, an alphabet store can be dynamically created and/or modified by one or more alphabet applications 1050 based on changes in the input patterns 1010 received by the selection component 1030. An alphabet application 1050 can be, for example, a specific application executed by a user 10, a dedicated alphabet generation program, and/or an operating system for a mobile device utilizing the input manager 30.

By way of specific, non-limiting example, an input manager 30 employed by a mobile device can allow a user 10 to provide voice commands while interacting with a standard numerical keypad at the mobile device. Using these input modalities, the mobile device can provide a user interface with a list of options such as menu options, predictions of keypad input according to T9 or a similar prediction format, and/or other appropriate options for streamlining input. The selection component 1030 at the input manager 30 can directly receive user input from the numeric keypad, from which an appropriate alphabet store 1040 can be generated. The input manager 30 can then allow a user to speak a command, such as “selection #3,” in lieu of scrolling down a potentially long menu with the numeric keypad. The sensing component 1020 can process the spoken command, from which the selection component can then make an appropriate selection from an alphabet store 1040.

As another specific, non-limiting example, brain activity of a user 10 can be monitored with respect to interactions between a user 10 and an input peripheral connected to the input manager 30. For example, a user 10 can connect a full-sized keyboard to the input manager 30 and interact with the keyboard to provide input to the selection component 1030. An alphabet store 1040 can then be generated that corresponds to a set of possible intended keystrokes based on a current keystroke received by the user 10 and/or a predetermined selection of previous keystrokes. For example, the alphabet store 1040 for a given keystroke can correspond to a received keystroke in addition to a selection of possible alternate keystrokes that may have been intended by the user 10 in the event that the received keystroke is erroneous. Based on brain activity monitored by the sensing component 1020, the selection component 1030 can then determine whether a current keystroke is correct and, if the current keystroke is incorrect, which keystroke was actually intended by the user 10.

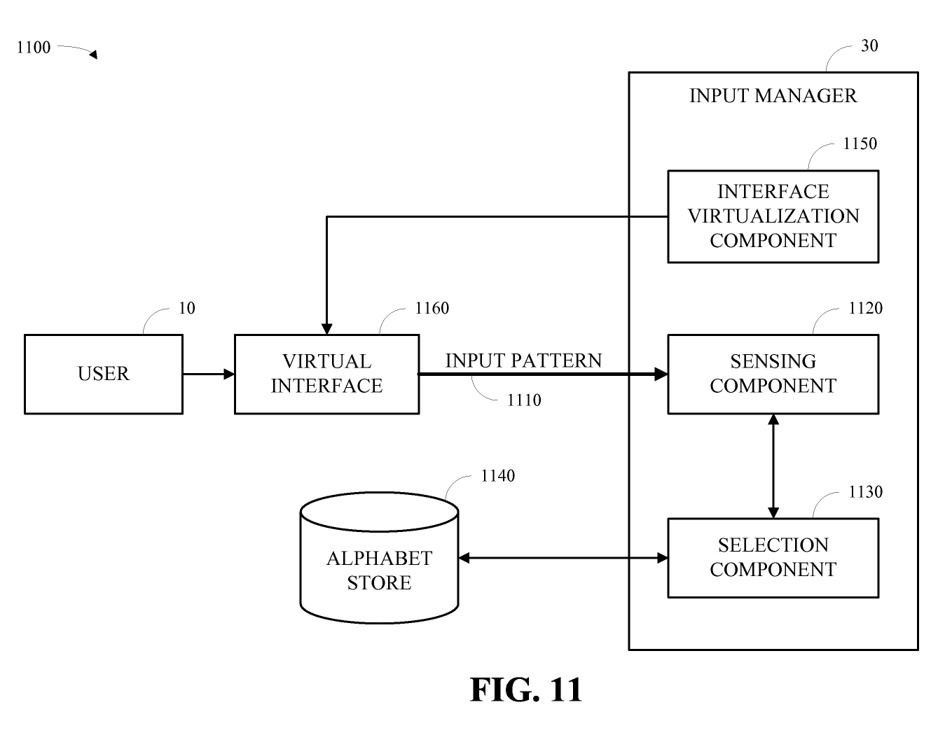

FIG. 11 illustrates a block diagram of a system 1100 for providing input to a size-constrained device (e.g., a mobile device 20) via a virtual interface 1160. In accordance with one aspect, a size-constrained device can include an input manager 30, which in turn can employ an interface virtualization component 1150 to convey a virtual interface 1160 to a user 10. Interactions between the user 10 and the virtual interface 1160 can be monitored for input patterns 1110 by a sensing component 1120 at the input manager 30, and the sensed input patterns 1110 can then be used by a selection component 1130 at the input manager 30 to select an appropriate input from one or more alphabet stores 1140.

In accordance with another aspect, a virtual interface 1160 provided by the interface virtualization component 1150 can be conveyed to a user 10 in such a manner as to create an appearance to the user 10 that the virtual interface 1160 is a full-sized and fully functional input device. The virtual interface 1160 can be modeled to appear substantially similar to a conventional input device, such as a keyboard or a mouse, and/or any other suitable input mechanism. It is to be appreciated that the interface virtualization component 1150 can convey a virtual interface 1160 to a user 10 in any way sufficient to create a usable representation of an input device for the user 10. For example, the interface virtualization component 1150 can employ one or more video projectors to project a virtual interface 1160 as an image having the appearance of an input device. Alternatively, the interface virtualization component 1150 can communicate with a display screen and/or a self-illuminating surface for the display of a virtual interface 1160 thereon.

As a specific, non-limiting example, a virtual interface 1160 can be a virtual keyboard, which can be projected by the interface virtualization component 1150 onto a surface. A user 10 can then interact with the virtual keyboard by typing against it, and input patterns 1110 associated with movements of the user 10 relative to the virtual keyboard can be sensed by a video camera and/or another appropriate sensing device at the sensing component 1120. From the sensed movements, the selection component 1130 can then recognize desired input from an alphabet store 1140. Thus, by providing a virtual interface 1160 in the form of a virtual keyboard, a user 10 can type against a conceivably full-sized and full-featured keyboard that is comfortable and adaptable, yet also small and easily portable since it is virtualized. Additionally and/or alternatively, the sensing component 1120 can employ a low-cost biometric device to monitor, for example, brainwave patterns of the user 10 to aid in assigning a keystroke on the virtual keyboard to a selection from the alphabet store 1140. Further, the sensing component 1120 can also utilize additional imaging devices to monitor the movement and/or trajectory of fingerstrokes and/or keystrokes of a user 10 relative to the virtual interface 1160.

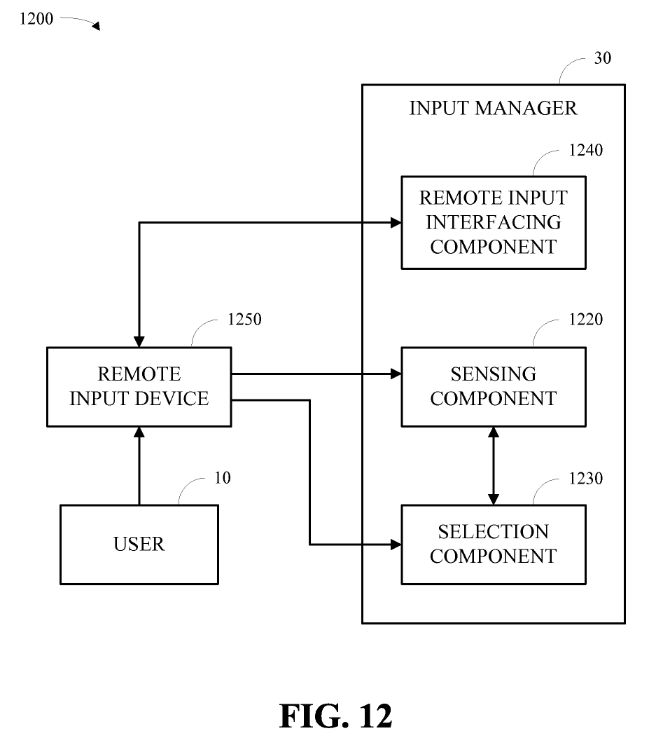

Referring to FIG. 12, a block diagram of a system 1200 for providing input to a mobile device (e.g. a mobile device 20) via a remote input device 1250 is illustrated. In accordance with one aspect, a mobile device can utilize an input manager 30 having a remote input interfacing component 1240 to establish a communication session with a remote input device 1250. A communication session between the remote input interfacing component 1240 and a remote input device 1250 can be initiated, for example, at the request of a user 10 and/or automatically by the remote input interfacing component 1240 or another appropriate entity upon the detection of a usable remote input device 1250 in range of the user 10. Once a communication session is initiated, a user 10 can interact with the remote input device 1250 to provide input for the mobile device to the input manager 30. In one example, a remote input device 1250 can be a conventional input device, such as a keyboard, mouse, touch pen, and/or another appropriate input device. Alternatively, a remote input device 1250 can be a specialized input device and/or any other suitable input device for providing input to a mobile device. Further, a sensing component 1220 and/or a selection component 1230 can additionally be used to monitor input patterns associated with interactions between a user 10 and a remote input device 1250 and to determine appropriate inputs therefrom in accordance with various aspects described herein.

By way of specific, non-limiting example, a remote interfacing component 1240 can utilize an infrastructure of available remote input devices 1250 such as keyboards. In one example, each keyboard and/or other remote input device 1250 in the infrastructure can communicate with a remote interfacing component 1240 over a network or internetwork via a suitable wireless communication technology. In addition, keyboards and/or other remote input devices 1250 included in the infrastructure can be deployed at particular useful locations that can be quickly and easily accessed by small form-factor devices, such as in conference rooms, on airplanes, and/or in any other suitable locations. When a user 10 comes within range of such a remote input device 1250, the user 10 can access the remote input device 1250. Alternatively, access to the remote input device 1250 can be established automatically without a specific request from the user 10. Once access to a remote input device 1250 is established, the user 10 can provide input to a mobile device associated with the input manager 30 using the remote input device. Accordingly, a user 10 can utilize an infrastructure of remote input devices 1250 to provide convenient, intuitive, and fully-functional input to a mobile device in any location where mobile devices are frequently accessed.

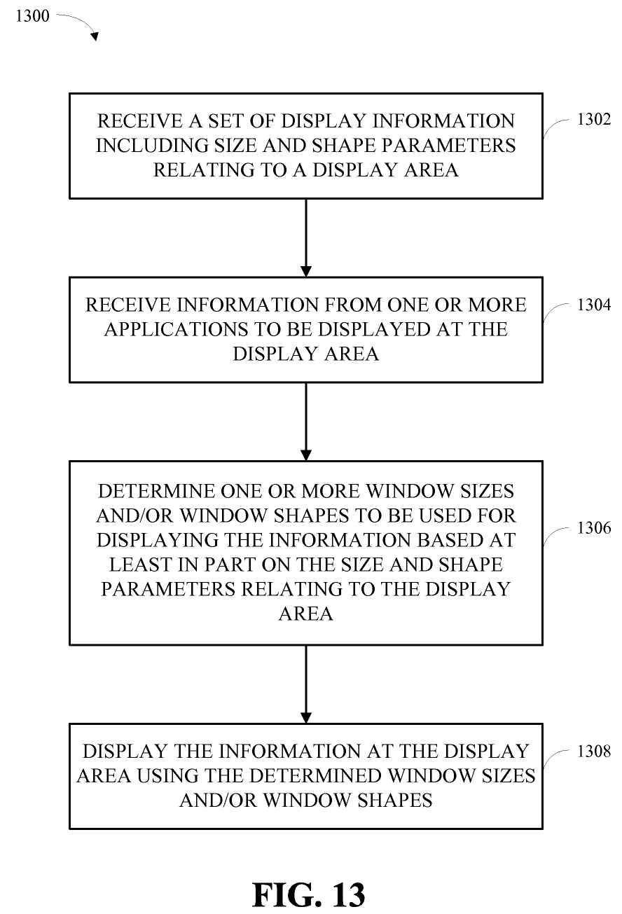

Turning to FIGS. 13-15, methodologies that may be implemented in accordance with features presented herein are illustrated via series of acts. It is to be appreciated that the methodologies claimed herein are not limited by the order of acts, as some acts may occur in different orders, or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as claimed herein.

Turning to FIG. 13, a method 1300 of generating and utilizing a layout for the display of a user interface (e.g. an application interface 660) at a display area (e.g., display area 650) is illustrated. Method 1300 can be used, for example, by a mobile device (e.g., a mobile device 20) and/or another suitable device to display information on a local display screen associated with the device (e.g., a local display 860), an external display screen communicatively connected to the device (e.g., an external display 880), or a combination thereof. At 1302, a set of display information (e.g., a set of information including display parameters 620) that includes size and shape parameters (e.g., display size parameters 622 and display shape parameters 624) relating to a display area (e.g. display area 650) is received. In one example, user preferences (e.g. user preferences 522) and/or other appropriate information can be received in addition to size and shape parameters at 1302.

Next, at 1304, information from one or more applications to be displayed at the display area (e.g. application interface data 512) is received. At 1306, one or more window sizes (e.g., window sizes 664) and/or window shapes (e.g. window shapes 662) to be used for displaying the information received at 1304 is determined (e.g., by a layout determination component 642) based at least in part on the size and shape parameters relating to the display area received at 1302. In addition to the size and shape parameters, other information received at 1302, such as user preferences, can also be utilized at 1306. At 1308, the information received at 1304 is displayed at the display area using the determined window sizes and/or window shapes.

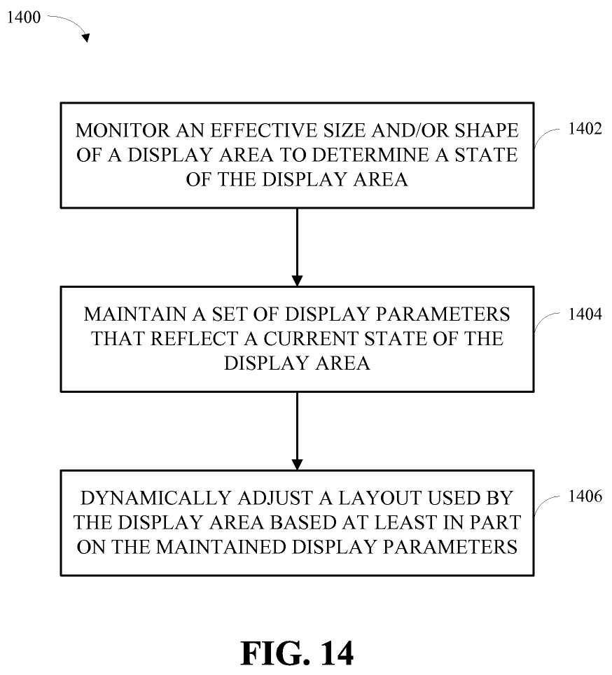

Referring now to FIG. 14, a method 1400 of dynamically generating and adjusting a layout for a display area is illustrated. Similar to method 1300, method 1400 can be used by a mobile device and/or another suitable device to display information on a local display screen associated with the device, an external display screen communicatively connected to the device, or a combination thereof. At 1402, an effective size and/or shape of a display area (e.g., a display area 750) is monitored (e.g., by a display state sensing component 720) to determine a state of the display area (e.g., a display state 760). At 1404, a set of display parameters (e.g., display parameters 722) is maintained that reflect a current state of the display area. At 1406, a layout used by the display area is dynamically adjusted (e.g., by a layout determination component 742) based at least in part on the display parameters maintained at 1404.

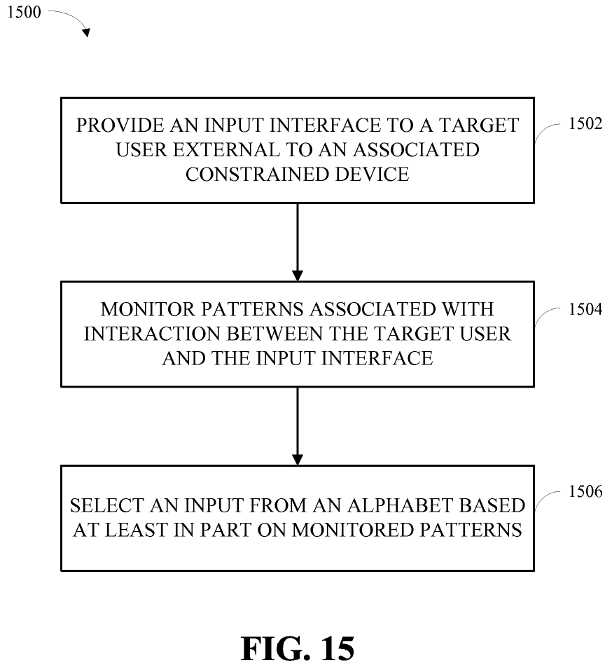

Referring to FIG. 15, a flowchart of a method 1500 of receiving and processing user input patterns from an external input interface is illustrated. At 1502, an input interface is provided (e.g., by an input manager 30) to a target user (e.g. a user 10) external to an associated constrained device (e.g. a mobile device 20 or another suitable device). In one example, the input interface provided at 1502 can be a virtualized interface (e.g., a virtual interface 1160 provided by an interface virtualization component 1150), which can represent a keyboard or another appropriate input peripheral. At 1504, patterns (e.g., input patterns 910) associated with interaction between the target user and the input interface are monitored (e.g. by a sensing component 920). Monitoring at 1104 can be performed, for example, using one or more of motion tracking, position tracking, imaging, biometric, speech recognition, and/or other monitoring technologies. At 1506, an input is selected (e.g. by a selection component 930) from an alphabet (e.g., an alphabet store 940) based at least in part on the patterns monitored at 1504.

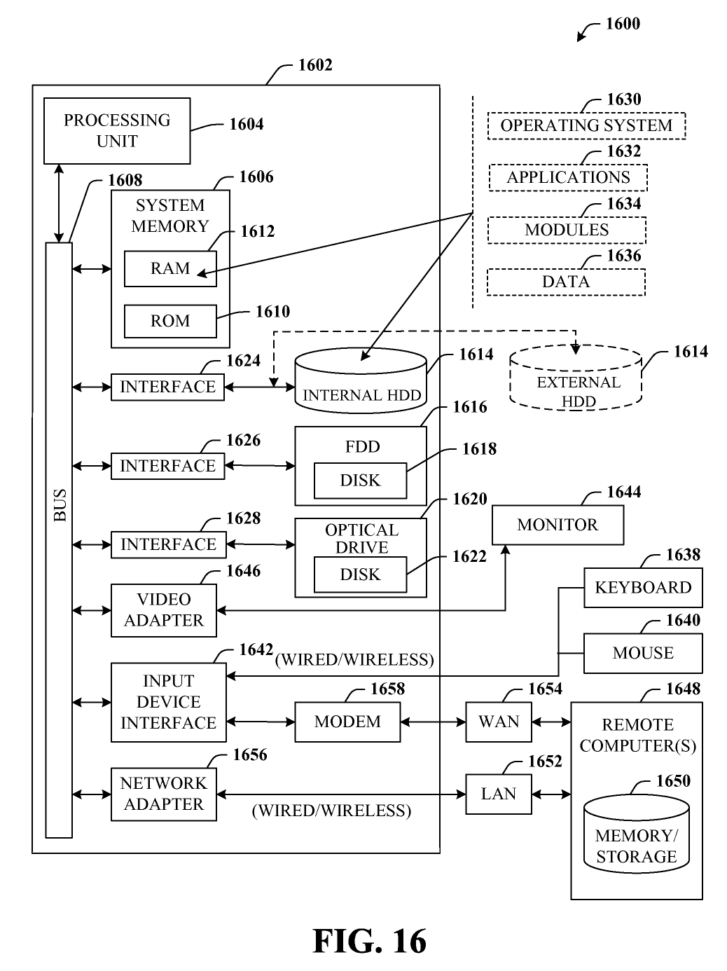

In order to provide additional context for various aspects described herein, FIG. 16 and the following discussion are intended to provide a brief, general description of a suitable computing environment 1600 in which various aspects of the claimed subject matter can be implemented. Additionally, while the above features have been described above in the general context of computer-executable instructions that may run on one or more computers, those skilled in the art will recognize that said features can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 16, an exemplary environment 1600 for implementing various aspects described herein includes a computer 1602, the computer 1602 including a processing unit 1604, a system memory 1606 and a system bus 1608. The system bus 1608 couples to system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that the claimed subject matter can be implemented with various commercially available operating systems or combinations of operating systems.

A user can enter commands and information into the computer 1602 through one or more wired/wireless input devices, e.g. a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, a serial port, an IEEE-1394 port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which may connect to a global communications network, e.g., the Internet.

When used in a LAN networking environment, the computer 1602 is connected to the local network 1652 through a wired and/or wireless communication network interface or adapter 1656. The adapter 1656 may facilitate wired or wireless communication to the LAN 1652, which may also include a wireless access point disposed thereon for communicating with the wireless adapter 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10BaseT wired Ethernet network.

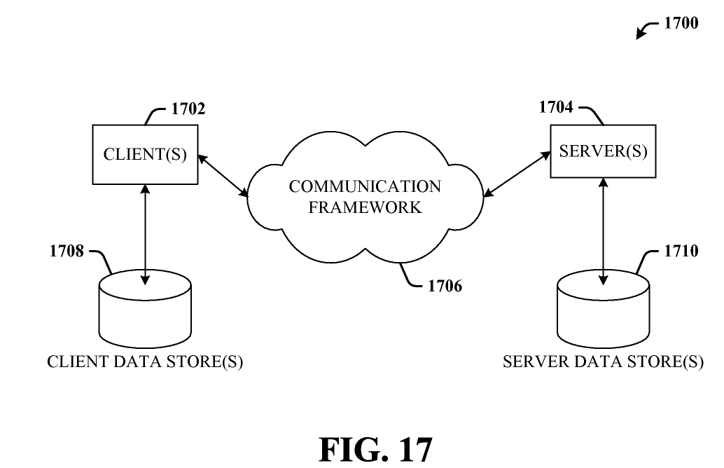

Referring now to FIG. 17, there is illustrated a schematic block diagram of an exemplary computer compilation system operable to execute the disclosed architecture. The system 1700 includes one or more client(s) 1702. The client(s) 1702 can be hardware and/or software (e.g. threads, processes, computing devices). In one example, the client(s) 1702 can house cookie(s) and/or associated contextual information by employing one or more features described herein.

The system 1700 also includes one or more server(s) 1704. The server(s) 1704 can also be hardware and/or software (e.g., threads, processes, computing devices). In one example, the servers 1704 can house threads to perform transformations by employing one or more features described herein. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g. a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates the display of a user interface, comprising:
a sensing component that determines shape of a display area; and
an adjustment component that adjusts shape of respective graphics to be displayed at the display area based on the determined shape of the display area and respective positions of the graphics within the display area.

2. The system of claim 1, wherein the adjustment component adjusts shape of the at least one window based on contextual information relating to one or more of content to be displayed in the display area, identity of a user of the display area, or location of the display area.

3. The system of claim 2, wherein the adjustment component adjusts shape of the at least one window such that the at least one window conforms in shape to the display area or a portion of the display area in which the at least one window is located.

4. The system of claim 1, wherein the adjustment component dynamically adjusts shape of respective graphics based on movement of the respective graphics within the display area.

5. The system of claim 1, wherein the sensing component and the adjustment component are associated with a projector and the display area comprises a projection area onto which the projector displays a user interface.

6. The system of claim 5, wherein the sensing component comprises a feedback device that continuously determines a viewable portion of the projection area and the adjustment component dynamically adjusts display of the user interface to accommodate the viewable portion of the projection area determined by the feedback device.

7. The system of claim 6, wherein the feedback device identifies one or more obstructed portions of the projection area and the adjustment component dynamically adjusts display of the user interface such that the identified obstructed portions of the projection area are not utilized for displaying the user interface.

8. The system of claim 6, wherein the projection area is a collapsible projection screen, the feedback device identifies an expanded portion of the projection screen, and the adjustment component dynamically adjusts display of the user interface such that the user interface is displayed on the expanded portion of the projection screen.

9. The system of claim 6, wherein the feedback device identifies an extent to which keystoning is present at the display area to facilitate automatic correction of the keystoning by the adjustment component.

10. The system of claim 1, wherein the feedback device comprises an optical sensor.

11. A method of configuring a user interface at a display area, comprising:
collecting information relating to shape of a display area;
identifying graphics to be displayed at the display area; and
adjusting respective shapes of the graphics based at least in part on the collected information relating to the shape of the display area.

12. The method of claim 11, wherein the identifying graphics to be displayed at the display area comprises identifying at least one window to be displayed at the display area.

13. The method of claim 12, wherein the adjusting respective shapes of the graphics comprises configuring shape of the at least one identified window to conform to the shape of the display area based on the collected information relating to the shape of the display area.

14. The method of claim 12, wherein the adjusting respective shapes of the graphics comprises dynamically configuring shape of the at least one identified window based on movement of the at least one identified window through the display area.

15. The method of claim 11, wherein the display area is a projection screen.

16. The method of claim 15, wherein the collecting information relating to shape of a display area comprises monitoring the projection screen to continuously determine a viewable portion of the projection screen.

17. The method of claim 16, wherein the monitoring the projection screen comprises monitoring the projection screen for one or more of an obstructed portion of the projection screen, a portion of the projection screen that has been rolled away or collapsed, or image skewing present at the projection screen.

18. The method of claim 11, further comprising collecting at least one of user preferences or contextual information relating to the display area, wherein the adjusting comprises adjusting respective shapes of the graphics based at least in part on the collected information relating to the shape of the display area and at least one of collected user preferences or collected contextual information relating to the display area.

19. A computer-readable medium having stored thereon computer-executable instructions operable to perform the method of claim 11.

20. A method of adaptively displaying information at a display area, comprising:
identifying information relating to shape of the display area and at least one of location of the display area, information to be displayed at the display area, or user preferences relating to the display area;
generating a first layout that specifies respective shapes for information to be displayed at the display area based on the collected information;
monitoring the collected information for changes thereto; and
upon discovering a change in the collected information, generating a second layout that specifies disparate respective shapes for information to be displayed at the display area based on the discovered change.
